(19) United States
(12) Patent Application Publication
(10) Pub. No.: US 2026/0329510 A1
(43) Pub. Date: Oct. 22, 2026

(54) DISPLAY WITH WIRELESS CHARGING FUNCTION

(71) Applicant: LITEMAX ELECTRONICS INC., New Taipei City (TW)

(72) Inventor: CHIN-CHEN LIU, New Taipei City (TW)

(73) Assignee: LITEMAX ELECTRONICS INC., New Taipei City (TW)

(21) Appl. No.: 19/182,672

(22) Filed: Apr. 18, 2025

(51) Int. Cl. G06F 3/14; G06T 3/40; H02J 7/00; H02J 50/10

(52) U.S. Cl. CPC G06F 3/1423; G06T 3/40; H02J 7/731; G06T 2210/36; H02J 50/10

(57) ABSTRACT

A display with a wireless charging function includes: a display module, having a top side and a bottom side, where a first display area is formed on the top side, and is configured to display, based on a display signal, first screen information corresponding to the display signal in the first display area; and a wireless charging transmission module, arranged between the top side and the bottom side and configured to provide a charging area in the first display area. When a portable electronic device is placed on the charging area, the wireless charging transmission module is configured to charge the portable electronic device in the wireless charging manner. The display module is configured to convert the first display area into a second display area that is smaller than the first display area, and display the first screen information that is scaled down in the second display area.

### BACKGROUND OF THE INVENTION

### 1. Field of the Invention

The disclosure relates to a display, and in particular, to a display with a wireless charging function.

### 2. Description of the Related Art

With the development of computer technologies, displays using a computer graphics technology are widely used on electronic game consoles. A user may perform operations (for example, moving a character, switching a screen, determining an option, canceling an option, and entering a word) on screen content presented on a display through a button arranged on an electronic game console or a touch function of the display, to achieve playing and entertainment.

As a time for which the user plays the electronic game console goes on, the user has a demand for charging a portable electronic device 20 (such as a smart phone). As shown in FIG. 1, the portable electronic device 20 is a smart phone with a wireless charging function, and a left side of an electronic game console display 10 is provided with a wireless charging area and marked with a wireless charging pattern 15, so as to prompt the user to place the portable electronic device 20 on the wireless charging area for wireless charging.

### BRIEF SUMMARY OF THE INVENTION

However, because the wireless charging area needs to be arranged on the left side of the electronic game console display 10, a space required for circuits that realize the wireless charging function is reserved on the left side of the electronic game console display 10. Therefore, the display area of the electronic game console display 10 is reduced by the wireless charging area, and an overall length of the display area of the electronic game console display 10 is reduced from L0 to L0′, that is, a display area A0. Therefore, the current wireless charging area configuration position leads to a problem of reduction in the display area of the electronic game console display.

To solve the foregoing problem, the disclosure provides a display with a wireless charging function, which is configured to charge a portable electronic device in a wireless charging manner. The display includes: a display module, having a top side and a bottom side, where a first display area is formed on the top side, and the display module is configured to display, based on a display signal, first screen information corresponding to the display signal in the first display area; and a wireless charging transmission module, arranged between the top side and the bottom side and electrically coupled to the display module. The wireless charging transmission module is configured to provide a charging area in the first display area. The portable electronic device has a wireless charging receiving module. When the portable electronic device is placed on the charging area, the wireless charging transmission module is configured to charge the portable electronic device through the wireless charging receiving module in the wireless charging manner. The display module is configured to convert the first display area into a second display area that is smaller than the first display area, and display the first screen information that is scaled down in the second display area.

In some embodiments, the display module further includes: a first display unit, configured to display the first screen information based on received first screen data; and an image processor unit, electrically coupled to the first display unit and configured to process the display signal to generate the first screen data and cause the display module to display the first screen information in the first display area.

In some embodiments, the image processor unit is further configured to process the display signal and generate second screen data corresponding to the first screen information that is scaled down to the first display unit, so that the first display unit displays the first screen information that is scaled down in the second display area.

In some embodiments, the image processor unit is further configured to define an area other than the second display area as a third display area, and display second screen information different from the first screen information that is scaled down in the third display area.

In some embodiments, the power required for the operation of the wireless charging transmission module is from the first display unit.

In some embodiments, the image processor unit is further configured to control the first display unit to convert the first display area into the second display area based on a charging preparation signal generated from the wireless charging transmission module.

In some embodiments, when the portable electronic device is removed from the charging area, the display module is configured to convert the second display area into the first display area, and display the first screen information that is restored to an original scale in the first display area.

In some embodiments, the portable electronic device further includes: a controller module, configured to control the operation of the wireless charging receiving module based on the control signal; a second display unit, electrically coupled to the controller module; and a battery module, electrically coupled to the second display unit, the controller module, and the wireless charging receiving module, where the battery module is configured to be charged through the wireless charging receiving module and provide power required for the operation of the portable electronic device.

In some embodiments, the charging area further correspondingly displays a wireless charging pattern or wireless charging information to prompt a user to place the portable electronic device on the charging area to charge the portable electronic device.

To sum up, compared with a conventional electronic game console display, in the display with a wireless charging function in the embodiments of the disclosure, the first display area is significantly larger than a display area of the conventional electronic game console display. Therefore, the display with a wireless charging function can display more screen information, and solve a problem that a current wireless charging area configuration position causes reduction in a display area of an electronic game console display. In addition, in the display module in the embodiments of the disclosure, through the image processor unit, the area other than the second display area may be defined as the third display area, and the second screen information different from the first screen information that is scaled down may be displayed in the third display area, so as to make full use of the display area in the display module and enrich the screen content presented on the display module.

### BRIEF DESCRIPTION OF THE DRAWINGS

FIG. 1 is a schematic diagram showing an electronic game console display and a portable electronic device during wireless charging in the prior art.

FIG. 2 is a system block diagram showing a display with a wireless charging function and a portable electronic device during charging according to an embodiment of the disclosure.

FIG. 3 is a schematic diagram showing a display area of the display with a wireless charging function according to an embodiment of the disclosure.

FIG. 4 is a schematic diagram showing the display area of the display with a wireless charging function and the portable electronic device during charging according to an embodiment of the disclosure.

FIG. 5 is a schematic perspective structural diagram in a direction S in FIG. 4 according to an embodiment of the disclosure.

FIG. 6 is a schematic diagram showing a display area of a display with a wireless charging function according to another embodiment of the disclosure.

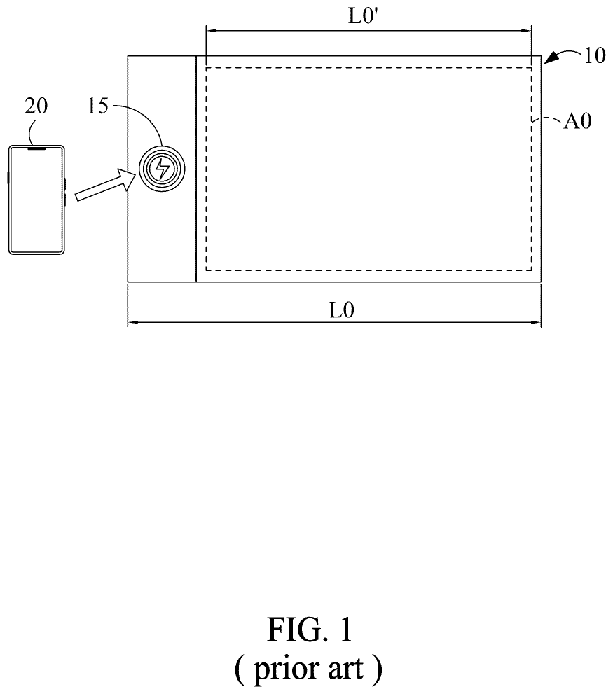

### DETAILED DESCRIPTION OF THE INVENTION

Specific structure or function descriptions in embodiments of the disclosure described in this specification are provided only as examples for describing embodiments according to the concept of the disclosure. The embodiments according to the concept of the disclosure may be practiced in various forms and should not be construed as being limited to the embodiments

### Described in the Specification.

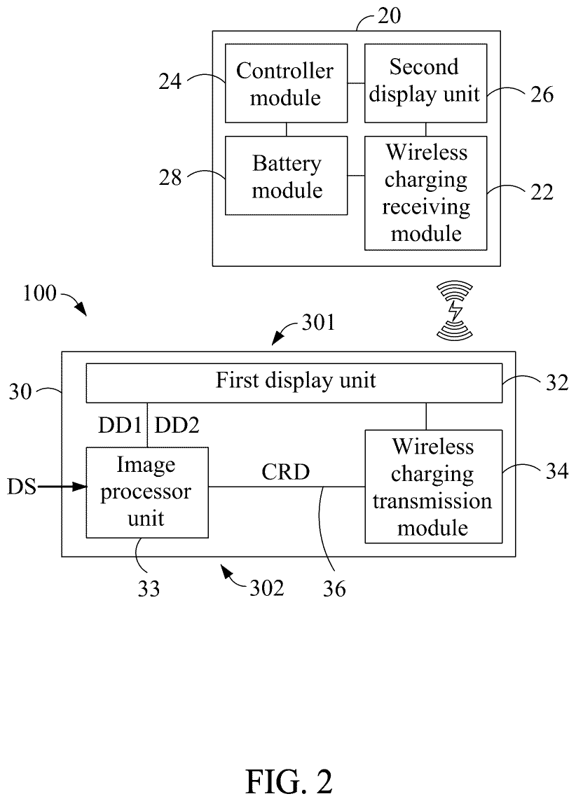

FIG. 2 is a system block diagram showing a display 100 with a wireless charging function and a portable electronic device 20 during charging according to an embodiment of the disclosure.

Referring to FIG. 2, the display 100 with a wireless charging function is configured to charge the portable electronic device 20 in a wireless charging manner. The display 100 with a wireless charging function may include a display module 30 and a wireless charging transmission module 34.

The display module 30 has a top side 301 and a bottom side 302. A first display area is formed on the top side 301. The display module 30 is configured to display, based on a display signal DS, first screen information corresponding to the display signal DS in a first display area.

The display module 30 may further include a first display unit 32 and an image processor unit 33.

The first display unit 32 is configured to display the first screen information C1 based on received first screen data DD1. In other embodiments, the image processor unit is further configured to process the display signal DS and generate second screen data DD2 corresponding to the first screen information C1′ that is scaled down to the first display unit 32, so that the first display unit 32 displays the first screen information C1′ that is scaled down in a second display area A2.

The image processor unit 33 is electrically coupled to the first display unit 32. The image processor unit 33 is configured to receive the display signal DS and process the display signal DS to generate the first screen data DD1. The image processor unit 33 can cause the display module 30 to display the first screen information C1 in the first display area A1. In other embodiments, the image processor unit 33 may control the first display unit 32 to convert the first display area A1 into the second display area A2 based on a charging preparation signal CRD generated from the wireless charging transmission module 34. The charging preparation signal CRD may refer to a flag signal indicating that the wireless charging transmission module 34 and a wireless charging receiving module 22 complete a charging preparation procedure.

The wireless charging transmission module 34 is arranged between the top side 301 and the bottom side 302 of the display module 30. The wireless charging transmission module 34 may be electrically coupled to the display module 30. More specifically, the wireless charging transmission module 34 may be electrically coupled to each circuit element in the display module 30. The wireless charging transmission module 34 is configured to provide a charging area WA in the first display area A1. The charging area WA in the first display area A1 may correspondingly display a wireless charging pattern WCP or wireless charging information, to prompt that a user may place the portable electronic device 20 on the charging area WA to charge the portable electronic device 20. In addition, power required for the operation of the wireless charging transmission module 34 may be from the first display unit 32.

The portable electronic device 20 has the wireless charging receiving module 22. When the portable electronic device 20 is placed on the charging area WA in the first display area A1, the wireless charging transmission module 34 charges the portable electronic device 20 through the wireless charging receiving module 22 in the wireless charging manner. The display module 30 converts the first display area A1 into the second display area A2 smaller than the first display area A1, and displays the first screen information C1′ that is scaled down in the second display area A2.

In other embodiments, when the portable electronic device 20 is removed from the charging area WA, the display module 30 is configured to convert the second display area A2 into the first display area A1, and display the first screen information C1 that is restored to an original scale in the first display area A1.

The portable electronic device 20 may further include the wireless charging receiving module 22, a controller module 24, a second display unit 26, and a battery module 28.

The wireless charging receiving module 22 is configured to be coupled to the wireless charging transmission module 34 to perform a wireless charging procedure. The wireless charging receiving module 22 and the wireless charging transmission module 34 may perform the wireless charging procedure by using interconnection standard for short-range (e.g., 40 mm) low-power wireless inductive power transfer formulated by the Wireless Power Consortium (WPC). The wireless charging receiving module 22 and the wireless charging transmission module 34 may be composed of circuit elements such as a coil, an alternating current/direct current conversion circuit, and a driving circuit.

The controller module 24 is electrically coupled to the wireless charging receiving module 22, the second display unit 26, and the battery module 28. The controller module 24 is configured to control the operation of the wireless charging receiving module 22, the second display unit 26, and the battery module 28 based on the control signal. The control signal may be a touch operation signal generated from the second display unit 26. In addition, the controller module 24 may detect the attachment or detachment of the wireless charging transmission module 34 through the wireless charging receiving module 22, to determine whether to start the wireless charging procedure. The controller module 24 may be composed of, for example, a central processing unit (CPU), a digital signal processor (DSP), an application processor, an application-specific integrated circuit (ASIC), a field-programmable gate array (FPGA), or other programmable logic devices (PLD).

The second display unit 26 is electrically coupled to the wireless charging receiving module 22, the controller module 24, and the battery module 28. The second display unit 26 is configured such that when the wireless charging procedure is started, the second display unit 26 can be controlled by the controller module 24 and display screen information including but not limited to: “Charging” and “Battery capacity”. The second display unit 26 may be composed of, for example, a touch screen, but is not limited thereto.

The battery module 28 is configured to be charged through the wireless charging receiving module 22 and provide power required for the operation of the portable electronic device 20. The battery module 28 may be composed of, for example, a lithium ion (or another material) secondary battery.

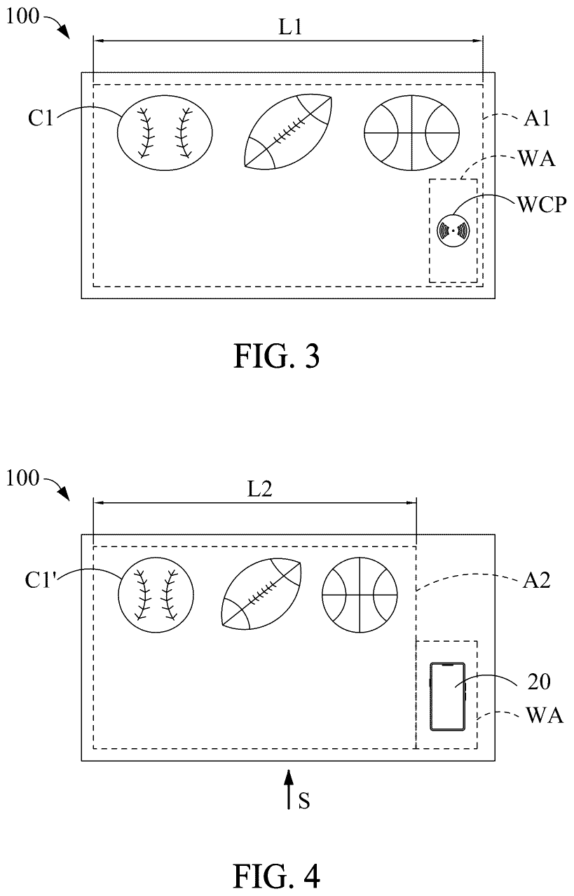

FIG. 3 is a schematic diagram showing a display area of the display 100 with a wireless charging function according to an embodiment of the disclosure.

Referring to FIG. 3, when the portable electronic device 20 is not placed on the charging area WA of the display 100 with a wireless charging function, the display area of the display 100 with a wireless charging function is the first display area A1, and the charging area WA is arranged at a lower right corner of the first display area A1, but is not limited thereto. In other embodiments, the charging area WA may be arranged at any position in the first display area A1 (e.g., an upper left corner, a middle, a lower left corner, or an upper right corner).

In this case, the first screen information C1 may be displayed in the first display area A1, and the wireless charging pattern WCP may be correspondingly displayed in the charging area WA to prompt the user that the portable electronic device 20 may be placed on the area to charge the portable electronic device 20. The first screen information C1 may be presented in the first display area A1 at a first display scale.

FIG. 4 is a schematic diagram showing the display area of the display 100 with a wireless charging function and the portable electronic device 20 during charging according to

### An Embodiment of the Disclosure.

Referring to FIG. 4, after the portable electronic device 20 is placed on the charging area WA of the display 100 with a wireless charging function, the display area of the display 100 with a wireless charging function is switched from the first display area A1 to the second display area A2 that is smaller than the first display area A1, and the first screen information C1′ that is scaled down is displayed in the second display area A2. A length L2 of the second display area A2 is less than a length L1 of the first display area A1. The first screen information C1′ that is scaled down may be presented in the second display area A2 at a second display scale. The second display scale may be less than the first display scale.

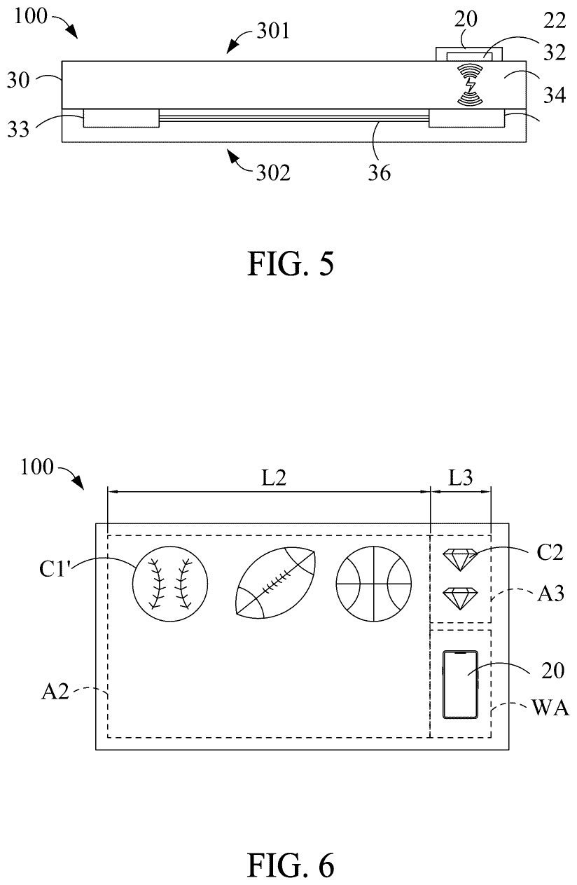

FIG. 5 is a schematic perspective structural diagram in a direction S in FIG. 4 according to an embodiment of the disclosure.

Referring to FIG. 5, it can be more clearly observed that the wireless charging transmission module 34 is arranged between the top side 301 and the bottom side 302 of the display module 30, and is located on a lower side of the first display unit 32. The wireless charging transmission module 34 may be electrically coupled to the image processor unit 33 through a bus 36 to transmit the charging preparation signal CRD.

FIG. 6 is a schematic diagram showing a display area of the display 100 with a wireless charging function according to another embodiment of the disclosure.

Referring to FIG. 6, the image processor unit 33 may further define an area other than the second display area A2 as a third display area A3, and display second screen information C2 (e.g., advertising information, ticker information, travel information, weather information, or traffic information) different from the first screen information C1′ that is scaled down in the third display area A3. A length L3 of the third display area A3 is less than the length L2 of the second display area A2. The display 100 with a wireless charging function can make full use of the display area in the display module 30 and enrich the screen content presented on the display module 30.

When the portable electronic device 20 is removed from the charging area WA, the display module 30 is configured to convert the second display area A2 into the first display area A1, and display the first screen information C1 that is restored to an original scale in the first display area A1. More specifically, the third display area A3 is incorporated in the first display area A1, and the third display area A3 and the first display area A1 jointly display the first screen information C1 that is restored to an original scale.

To sum up, compared with a conventional electronic game console display, in the display with a wireless charging function in the embodiments of the disclosure, the first display area is significantly larger than a display area of the conventional electronic game console display. Therefore, the display with a wireless charging function can display more screen information, and solve a problem that a current wireless charging area configuration position causes reduction in a display area of an electronic game console display. In addition, in the display module in the embodiments of the disclosure, through the image processor unit, the area other than the second display area may be defined as the third display area, and the second screen information different from the first screen information that is scaled down may be displayed in the third display area, so as to make full use of the display area in the display module and enrich the screen content presented on the display module.

The present invention is described by way of the preferred embodiments above. A person skilled in the art should understand that, these embodiments are merely for describing the present invention and are not to be construed as limitations to the scope of the present invention. It should be noted that all equivalent changes, replacements and substitutions made to the embodiments are to be encompassed within the scope of the present invention. Therefore, the scope of protection of the present invention should be accorded with the broadest interpretation of the appended claims.

What is claimed is:

1. A display with a wireless charging function, configured to charge a portable electronic device in a wireless charging manner, the display comprising:
a display module, having a top side and a bottom side, wherein a first display area is formed on the top side, and the display module is configured to display, based on a display signal, first screen information corresponding to the display signal in the first display area; and
a wireless charging transmission module, arranged between the top side and the bottom side and electrically coupled to the display module, wherein the wireless charging transmission module is configured to provide a charging area in the first display area;
the portable electronic device has a wireless charging receiving module, and when the portable electronic device is placed on the charging area, the wireless charging transmission module is configured to charge the portable electronic device through the wireless charging receiving module in the wireless charging manner, and the display module is configured to convert the first display area into a second display area that is smaller than the first display area, and display the first screen information that is scaled down in the second display area.

2. The display according to claim 1, wherein the display module further comprises:
a first display unit, configured to display the first screen information based on received first screen data; and
an image processor unit, electrically coupled to the first display unit and configured to process the display signal to generate the first screen data and cause the display module to display the first screen information in the first display area.

3. The display according to claim 2, wherein the image processor unit is further configured to process the display signal and generate second screen data corresponding to the first screen information that is scaled down to the first display unit, so that the first display unit displays the first screen information that is scaled down in the second display area.

4. The display according to claim 2, wherein the image processor unit is further configured to define an area other than the second display area as a third display area, and display second screen information different from the first screen information that is scaled down in the third display area.

5. The display according to claim 2, wherein power required for the operation of the wireless charging transmission module is from the first display unit.

6. The display according to claim 2, wherein the image processor unit is further configured to control the first display unit to convert the first display area into the second display area based on a charging preparation signal generated from the wireless charging transmission module.

7. The display according to claim 1, wherein when the portable electronic device is removed from the charging area, the display module is configured to convert the second display area into the first display area, and display the first screen information that is restored to an original scale in the first display area.

8. The display according to claim 1, wherein the portable electronic device further comprises:
a controller module, configured to control the operation of the wireless charging receiving module based on a control signal;
a second display unit, electrically coupled to the controller module; and
a battery module, electrically coupled to the second display unit, the controller module, and the wireless charging receiving module, wherein the battery module is configured to be charged through the wireless charging receiving module and provide power required for the operation of the portable electronic device.

9. The display according to claim 1, wherein the charging area further correspondingly displays a wireless charging pattern or wireless charging pattern information to prompt a user to place the portable electronic device on the charging area to charge the portable electronic device.
